(19) United States
(12) Patent Application Publication
(10) Pub. No.: US 2025/0275065 A1
(43) Pub. Date: Aug. 28, 2025

(54) ELECTRICAL JUNCTION BOX

(71) Applicant: Sumitomo Wiring Systems, Ltd., Yokkaichi-Shi, Mie (JP)

(72) Inventors: Satoru CHAEN, Yokkaichi-Shi, Mie (JP); Takayuki TANIGUCHI

(73) Assignee: Sumitomo Wiring Systems, Ltd., Yokkaichi-Shi, Mie (JP)

(21) Appl. No.: 18/857,630

(22) PCT Filed: Apr. 14, 2023
(86) PCT No.: PCT/JP2023/015133

§ 371 Date: Oct. 17, 2024

(30) Foreign Application Priority Data
Apr. 20, 2022 (JP) 2022-069353

(51) Int. Cl. H05K 5/00

(52) U.S. Cl. CPC H05K 5/0052

(57) ABSTRACT

An electrical junction box includes a circuit board, a first case including a first side wall and covering one surface of the circuit board, a second case covering another surface of the circuit board opposite the one surface. The first case includes a first contact portion that comes into contact with the one surface of the circuit board, and the second case includes a pair of second contact portions that come into contact with the other surface of the circuit board at two positions interposing the fitting hole therebetween, and a non-contact portion that does not to come into contact with the other surface between the pair of second contact portions in order to allow the flexural deformation of the second side wall.

### CROSS-REFERENCE TO RELATED APPLICATIONS

This application is the U.S. national stage of PCT/JP2023/015133 filed on Apr. 14, 2023, which claims priority of Japanese Patent Application No. JP 2022-069353 filed on Apr. 20, 2022, the contents of which are incorporated herein.

### TECHNICAL FIELD

The present disclosure relates to an electrical junction box.

### BACKGROUND

For example, an electrical junction box disclosed in JP 2011-114954A is known as an electrical junction box such as a junction box mounted in a vehicle. The electrical junction box disclosed in JP 2011-114954A is configured such that a circuit board is housed in a case formed by an upper case and a lower case. The circuit board is supported by the lower case from below and pressed, from above, by a wall portion protruding downward from the upper case side.

Generally, in the above electrical junction box, a crush rib is provided at a lower end of a wall portion on an upper case side in order to suppress looseness of a circuit board with an inexpensive configuration without using screws. The crush rib suppresses looseness of the circuit board by coming into contact with and being crushed by an upper surface of the circuit board. However, when the weight of the electrical junction box increases, the crush rib becomes easily worn due to vibrations, and looseness of the circuit board can be no longer suppressed.

In view of this, an object of the present disclosure is to provide an electrical junction box capable of effectively suppressing looseness of a circuit board without using screws.

### SUMMARY

An electrical junction box according to an aspect of the present disclosure is an electrical junction box including a circuit board, a first case including a first side wall and covering one surface of the circuit board, a second case including a second side wall that covers the first side wall from an outer side, the second case covering another surface of the circuit board opposite the one surface, and the first side wall includes a protruding portion protruding toward the second side wall, the second side wall includes a fitting hole into which the protruding portion is forcibly fitted by flexural deformation of the second side wall, the first case includes a first contact portion configured to come into contact with the one surface of the circuit board, and the second case includes a pair of second contact portions that come into contact with the other surface of the circuit board at two positions interposing the fitting hole of the second side wall therebetween, and a non-contact portion that does not to come into contact with the other surface between the pair of second contact portions in order to allow the flexural deformation of the second side wall.

An electrical junction box according to another aspect of the present disclosure is an electrical junction box including a circuit board, a first case including a first side wall and covering one surface of the circuit board, a second case including a second side wall that covers the first side wall from an outer side, the second case covering another surface of the circuit board opposite the one surface, and the first case includes a first contact portion that comes into contact with the one surface of the circuit board, and a claw body that is deformable in a curvature manner toward the second side wall side with respect to the first side wall, and the claw body allows the first contact portion to come into contact with the one surface of the circuit board by the curvature deformation, and is formed such that the claw body hooks onto the other surface of the circuit board by the curvature deformation being canceled in the state where the first contact portion is in contact with the one surface of the circuit board.

### Advantageous Effects of Disclosure

With an electrical junction box according to the present disclosure, it is possible to effectively suppress looseness of the circuit board without using screws.

### BRIEF DESCRIPTION OF DRAWINGS

FIG. 1 is a perspective view of an electrical junction box according to an embodiment.

FIG. 2 is an exploded perspective view of the electrical junction box.

FIG. 3 is a perspective view of a first case.

FIG. 4 is a cross-sectional view taken along arrow I-I in FIG. 3.

FIG. 5 is a plan view showing a state in which a second case of the electrical junction box is removed.

FIG. 6 is an enlarged perspective view showing a region of a first suppressing portion of the first case.

FIG. 7 is a cross-sectional view taken along arrow II-II in FIG. 3.

FIG. 8 is a perspective view of the second case as viewed from below.

FIG. 9 is a cross-sectional view taken along arrow III-III in FIG. 5.

FIG. 10 is a plan view of the second case as viewed from below.

FIG. 11 is a cross-sectional view taken along arrow IV-IV in FIG. 10.

FIG. 12 is a cross-sectional view showing a state before a protruding portion is forcibly fitted into a fitting hole.

### DETAILED DESCRIPTION OF PREFERRED EMBODIMENTS

First, the overview of embodiments of the present disclosure will be listed and described.

An electrical junction box according to the present disclosure is an electrical junction box including a circuit board, a first case including a first side wall and covering one surface of the circuit board, a second case including a second side wall that covers the first side wall from an outer side, the second case covering another surface of the circuit board opposite the one surface, and the first side wall includes a protruding portion protruding toward the second side wall, the second side wall includes a fitting hole into which the protruding portion is forcibly fitted by flexural deformation of the second side wall, the first case includes a first contact portion configured to come into contact with the one surface of the circuit board, and the second case includes a pair of second contact portions that come into contact with the other surface of the circuit board at two positions interposing the fitting hole of the second side wall therebetween, and a non-contact portion that does not to come into contact with the other surface between the pair of second contact portions in order to allow the flexural deformation of the second side wall.

According to the electrical junction box, in the state where the pair of second contact portions of the second case are in contact with the other surface of the circuit board, flexural deformation of the second side wall is allowed by the non-contact portion that is not in contact with the other surface. Accordingly, by the second side wall being deformed in a flexural manner, the protruding portion of the first side wall of the first case can be forcibly fitted into the fitting hole formed in the second side wall of the second case. As such, the circuit board is held while being sandwiched between the first contact portion of the first case and the second contact portion of the second case. Accordingly, it is possible to effectively suppress looseness of the circuit board without using screws.

It is preferable that the first case further includes a claw body that is deformable in a curvature manner toward the second side wall side with respect to the first side wall, and the claw body allows the first contact portion to come into contact with the one surface of the circuit board by the curvature deformation, and is formed such that the claw body hooks onto the other surface of the circuit board by the curvature deformation being canceled in the state where the first contact portion is in contact with the one surface of the circuit board.

In this case, by using curvature deformation of the claw body of the first case with respect to the first side wall, the circuit board is held while being sandwiched between the first contact portion of the first case and the claw body as well. This therefore makes it possible to further effectively suppress looseness of the circuit board.

It is preferable that the second case further includes a restricting portion that restricts the curvature deformation by coming into contact with the claw body in a state where the claw body hooks onto the other surface of the circuit board.

In this case, due to the restricting portion of the second case, the claw body of the first case is held while hooking onto the other surface of the circuit board, and thus looseness of the circuit board can be more effectively suppressed.

An electrical junction box according to another aspect of the present disclosure is an electrical junction box including a circuit board, a first case including a first side wall and covering one surface of the circuit board, a second case including a second side wall that covers the first side wall from an outer side, the second case covering another surface of the circuit board opposite the one surface, and the first case includes a first contact portion that comes into contact with the one surface of the circuit board, and a claw body that is deformable in a curvature manner toward the second side wall side with respect to the first side wall, and the claw body allows the first contact portion to come into contact with the one surface of the circuit board by the curvature deformation, and is formed such that the claw body hooks onto the other surface of the circuit board by the curvature deformation being canceled in the state where the first contact portion is in contact with the one surface of the circuit board.

According to the electrical junction box, by using the flexural deformation of the claw body of the first case with respect to the first side wall, the claw body of the first case hooks onto the other surface of the circuit board while the one surface of the circuit board is in contact with the first contact portion of the first case. With this, the circuit board is held while being sandwiched between the first contact portion and the claw body. Accordingly, it is possible to effectively suppress looseness of the circuit board without using screws.

Hereinafter, details of embodiments of the present disclosure will be described below with reference to the drawings. Note that, the embodiments described below may be at least partially combined in any way.

### Configuration of Electrical Junction Box

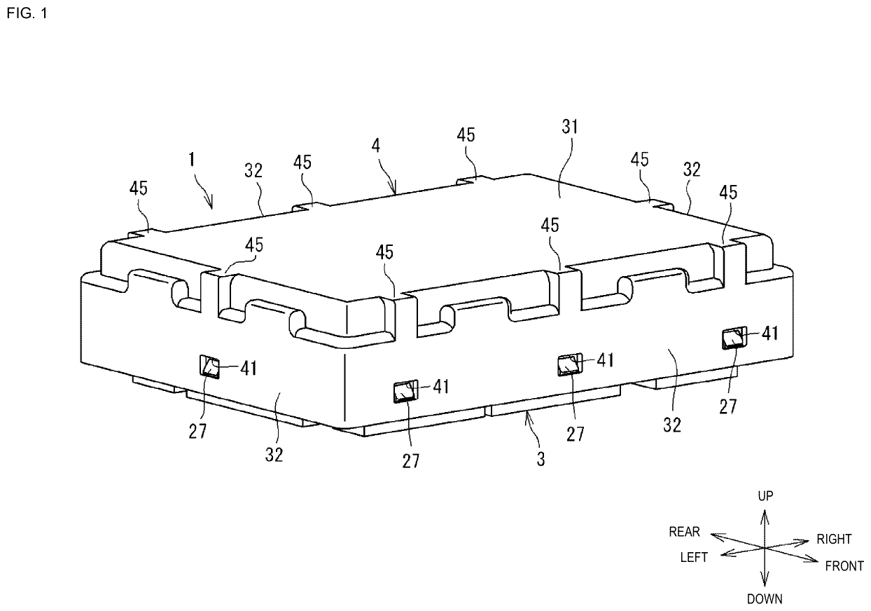

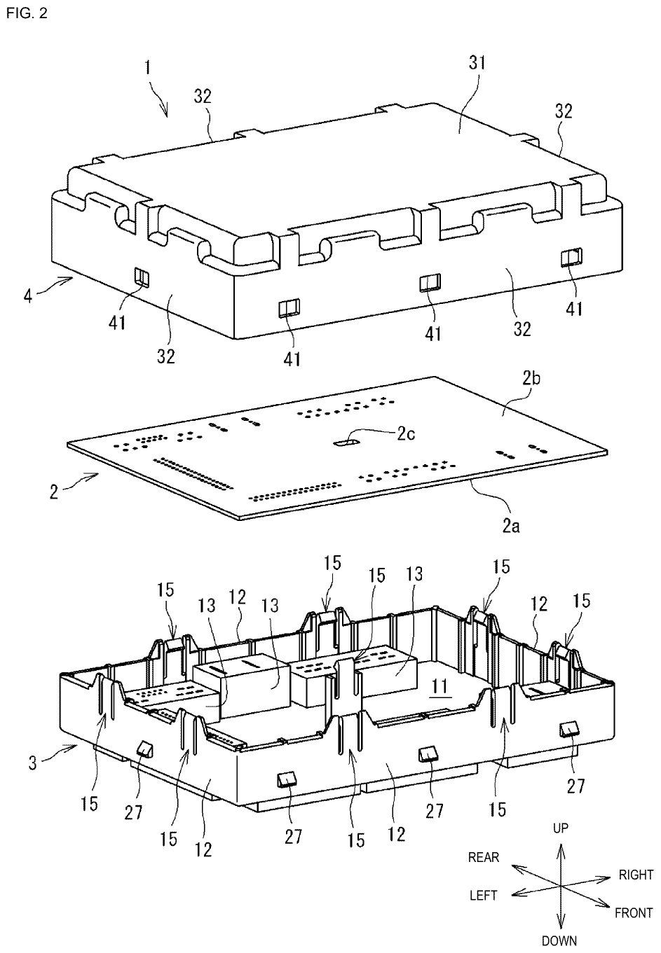

FIG. 1 is a perspective view of an electrical junction box 1 according to the present embodiment. FIG. 2 is an exploded perspective view of the electrical junction box 1. In the following description of the present embodiment, directions such as “Up”, “Down”, “Right”, “Left”, “Front” and “Rear” indicate directions shown in FIG. 2. In FIGS. 1 and 2, the electrical junction box 1 includes a circuit board 2, a first case 3, and a second case 4.

The circuit board 2 is constituted by a printed board, for example. One end of a plurality of connection terminals (not shown) is connected to the circuit board 2. The circuit board 2 is attached to the first case 3. The attachment structure will be described in detail later.

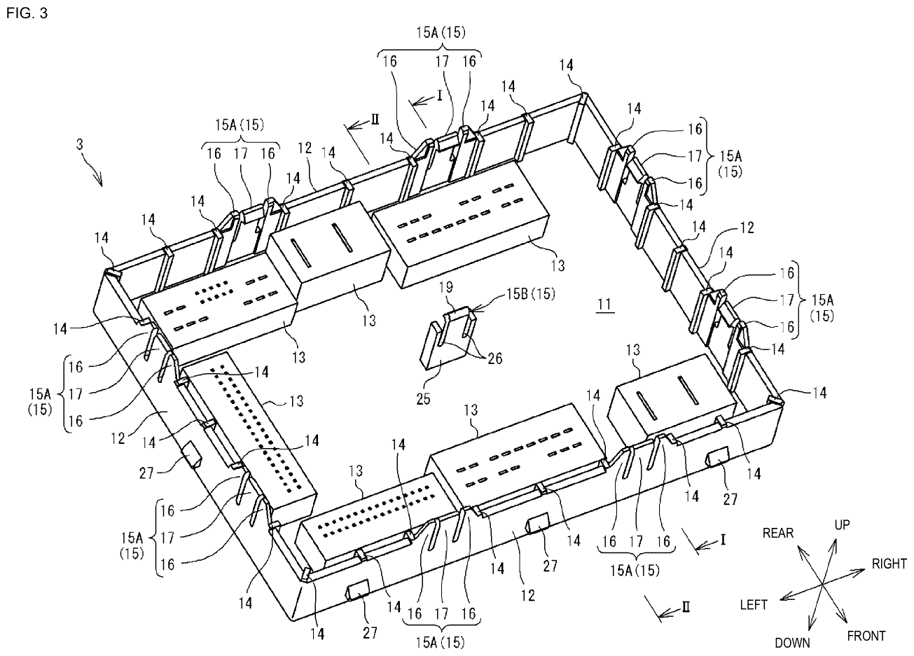

The first case 3 is a case that covers a lower surface 2a (one surface) of the circuit board 2. The first case 3 is an insulating body made of a synthetic resin, for example. The first case 3 has a rectangular box shape that is open upward. The first case 3 has a bottom wall 11 and four first side walls 12 respectively extending upward from front, rear, left, and right end portions of the bottom wall 11. The bottom wall 11 has a size capable of covering the lower surface 2a of the circuit board 2. The bottom wall 11 has a plurality of connectors 13 to which other ends of the plurality of connection terminals are to be connected (see also FIG. 3).

The second case 4 is a case that covers an upper surface (other surface) 2b of the circuit board 2. The second case 4 is an insulating body made of a synthetic resin, for example. The second case 4 has a rectangular box shape that is open downward. The second case 4 is fixed to the first case 3. The fixing structure will be described in detail later. The second case 4 has a bottom wall 31 and four second side walls 32 respectively extending downward from front, rear, left, and right end portions of the bottom wall 31. The bottom wall 31 has a size capable of covering the upper surface 2b of the circuit board 2.

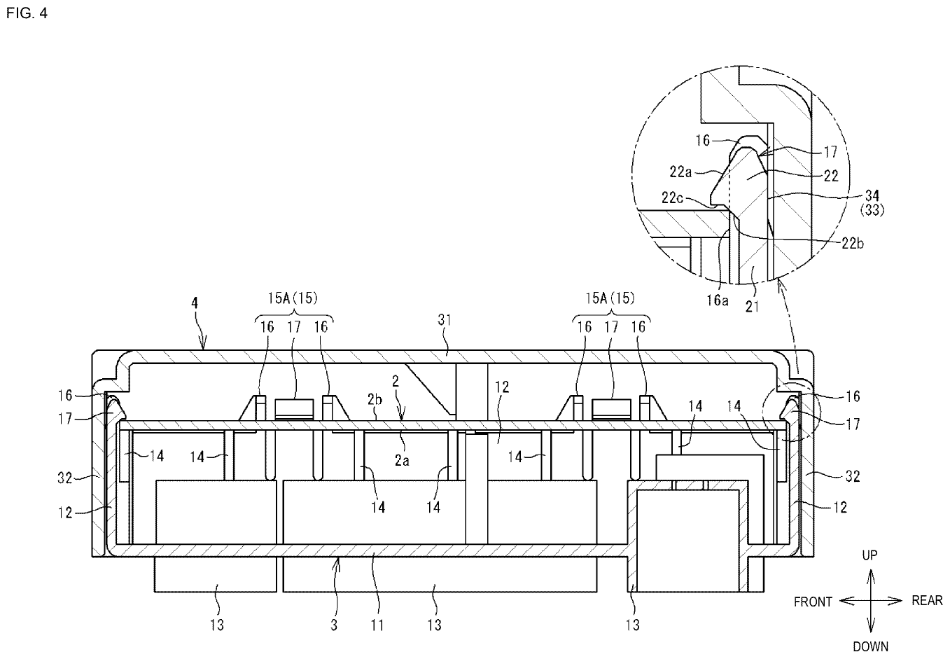

The second side walls 32 of the second case 4 cover the first side walls 12 of the first case 3 from the outer side (see also FIG. 4). Specifically, the front second side wall 32 of the second case 4 covers the front first side wall 12 of the first case 3 from the front. The rear second side wall 32 of the second case 4 covers the rear first side wall 12 of the first case 3 from the rear. The right second side wall 32 of the second case 4 covers the right first side wall 12 of the first case 3 from the right. The left second side wall 32 of the second case 4 covers the left first side wall 12 of the first case 3 from the left.

### Attachment Structure of Circuit Board in First Case

FIG. 3 is a perspective view of the first case 3. FIG. 4 is a cross-sectional view taken along arrow I-I in FIG. 3. FIG. 4 also shows a cross-sectional view of the circuit board 2 and the second case 4 in the state shown in FIG. 1. In FIGS. 3 and 4, the first case 3 includes a plurality of first contact portions 14 that come into contact with the lower surface 2a of the circuit board 2. The plurality of first contact portions 14 are provided on each of the first side walls 12 at intervals in the longitudinal direction. In the present embodiment, the first contact portion 14 is also provided at corners where the adjacent first side walls 12 are connected to each other.

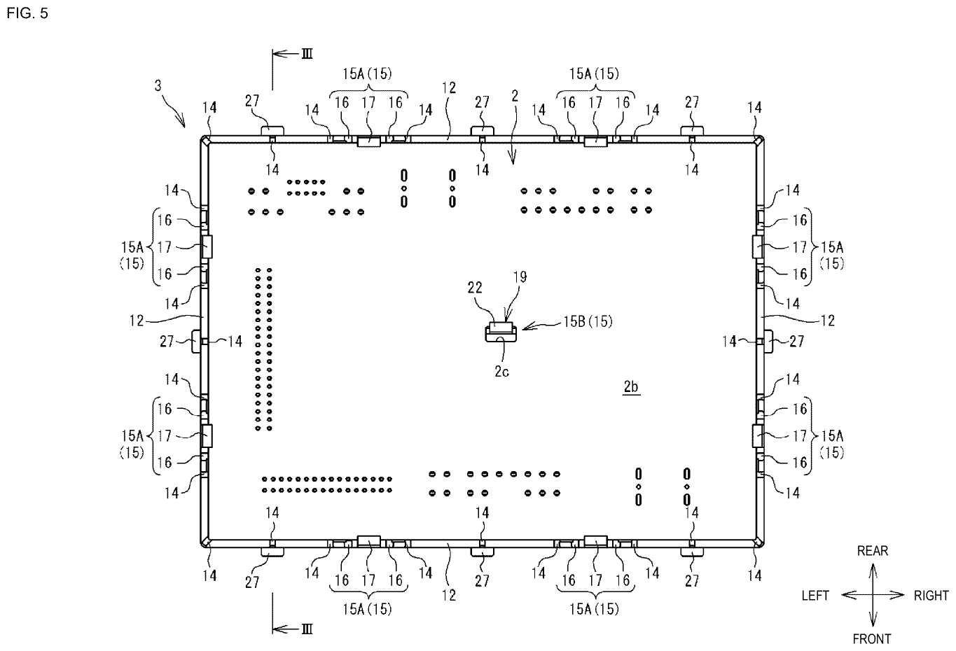

Each of the first contact portions 14 protrudes inward from the corresponding first side wall 12 or the corners and extends in the up-down direction. The upper surfaces of the first contact portions 14 protrude upward from the upper surfaces of the first side walls 12. FIG. 5 is a plan view showing a state in which the second case 4 of the electrical junction box 1 is removed. As shown in FIGS. 4 and 5, front, rear, left, and right end portions of the lower surface 2a of the circuit board 2 are in surface contact with the upper surfaces of the first contact portions 14 of the first case 3. In this manner, the circuit board 2 is mounted at an opening end of the first case 3.

In FIGS. 3 and 5, the first case 3 has a plurality of suppressing portions 15 that suppress looseness of the circuit board 2 while the circuit board 2 is in contact with the plurality of first contact portions 14. In the present embodiment, the plurality of suppressing portions 15 include two first suppressing portions 15A provided at intervals on each of the first side walls 12, and one second suppressing portion 15B provided in the center of the bottom wall 11.

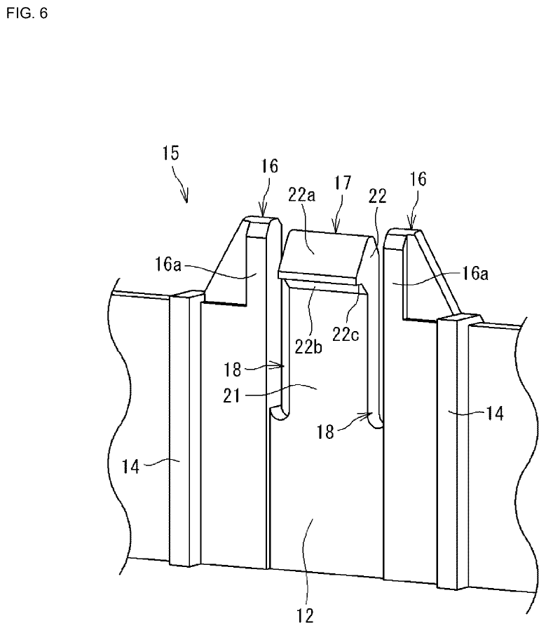

FIG. 6 is an enlarged perspective view showing a region of one of the first suppressing portions 15A of the first case 3. In FIGS. 4 and 6, the first suppressing portions 15A each include a pair of plate bodies 16 and a claw body 17 disposed between the pair of plate bodies 16. The pair of plate bodies 16 of the first suppressing portion 15A are configured to suppress looseness of the circuit board 2 in a horizontal direction. The pair of plate bodies 16 are provided between the adjacent first contact portions 14 of the first side walls 12.

The plate bodies 16 have a substantially trapezoidal shape in side view, for example. The plate bodies 16 protrude from upper surface of the first side walls 12 upward relative to the upper surfaces of the first contact portions 14. In this manner, an inner surface 16a of each of the plate bodies 16 is disposed so as to oppose a corresponding side surface of the circuit board 2 that is in contact with the upper surfaces of the first contact portions 14. Accordingly, by the opposing side surfaces of the circuit board 2 coming into contact with the inner surface 16a of each plate body 16 of the plurality of first suppressing portions 15A, looseness of the circuit board 2 in the horizontal direction (the front-rear direction and the left-right direction) is suppressed (see also FIG. 5).

The claw bodies 17 of the first suppressing portions 15A are configured to suppress looseness of the circuit board 2 in the up-down direction. Each claw body 17 is provided between the pair of plate bodies 16 of the first side walls 12. Each claw body 17 of the present embodiment is provided between a pair of slits 18 in the corresponding first side wall 12 formed by the slits 18 being cut out in the up-down direction. Each claw body 17 includes a body portion 21 and a hook portion 22 provided at an upper end portion of the body portion 21.

The body portions 21 have a flat plate shape elongated in the up-down direction. The body portions 21 protrude upward relative to the upper surfaces of the first contact portions 14. Each body portion 21 is deformable in a curvature manner outward (second side walls 32 side) with respect to the corresponding first side wall 12 using the lower end portion thereof as the starting point. Each hook portion 22 protrudes inward at the upper end portion of the body portion 21. A guide surface 22a is formed on the upper side of each hook portion 22. The guide surface 22a extends obliquely inward and downward from an upper end of the corresponding hook portion 22.

A taper surface 22b and a flat surface 22c are formed on the lower side of

each hook portion 22. The taper surface 22b extends obliquely upward and inward from an inner surface of each body portion 21. The taper surface 22b is formed such that the lower surface 2a of the circuit board 2 comes into line contact with and hooks onto an end edge portion (edge portion) of the upper surface 2b of the circuit board 2 in the state where the lower surface 2a of the circuit board 2 is in contact with the first contact portion 14. A flat surface 22c horizontally expands inward from an upper end of each taper surface 22b. The flat surface 22c is disposed so as to oppose the upper surface 2b of the circuit board 2 in the state where the lower surface 2a of the circuit board 2 is in contact with the first contact portions 14.

In FIG. 3, an upright piece 25 is provided in a center portion of an upper surface of the bottom wall 11. The upright piece 25 has a second suppressing portion 15B. The second suppressing portion 15B has a claw body 19. The claw body 19 is configured to suppress looseness of the circuit board 2 in the up-down direction. The claw body 19 in the present embodiment is provided between a pair of slits 26 by the slits 26 being cut out in the up-down direction on the left and right sides of the upright piece 25.

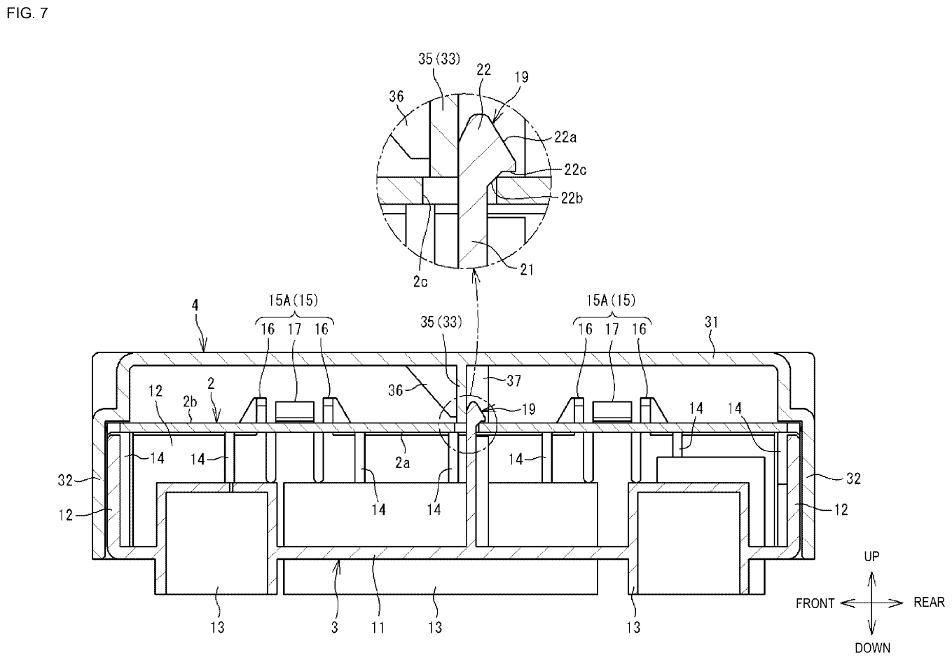

FIG. 7 is a cross-sectional view taken along arrow II-II in FIG. 3. FIG. 7 also shows cross-sections of the circuit board 2 and the second case 4 in the state shown in FIG. 1. In FIGS. 5 and 7, similarly to the claw bodies 17 of the first suppressing portions 15A, the claw body 19 includes the body portion 21 and the hook portion 22. The body portion 21 of the claw body 19 is deformable in a curvature manner toward the second side wall 32 side with respect to the upright piece 25 using the lower end portion as the starting point. Note that the body portion 21 may also be deformable in a curvature manner rearward, rightward, or leftward with respect to the upright piece 25.

The hook portion 22 of each claw body 19 protrudes rearward at the upper end portion of the body portion 21. The hook portion 22 has a size capable of allowing the hook portion 22 to pass through a through hole 2c formed in a center portion of the circuit board 2 in the state where the lower surface 2a of the circuit board 2 is in contact with the first contact portions 14.

The guide surface 22a of the hook portion 22 extends obliquely downward and rearward from an upper end of the hook portion 22. The taper surface 22b of the hook portion 22 extends obliquely upward and rearward from a rear surface of the body portion 21. The taper surface 22b is formed such that the lower surface 2a of the circuit board 2 comes into line contact with and hooks onto the opening edge portion (edge portion) of the through hole 2c of the upper surface 2b of the circuit board 2 in the state where the lower surface 2a of the circuit board 2 is in contact with the first contact portions 14. The flat surface 22c of the hook portion 22 horizontally extends rearward from an upper end of the taper surface 22b. The flat surface 22c of the hook portion 22 is disposed so as to oppose the upper surface 2b of the circuit board 2 in the state where the lower surface 2a of the circuit board 2 is in contact with the first contact portions 14.

With the above configuration, when attaching the circuit board 2 to the first case 3, the circuit board 2 is moved downward from the state shown in FIG. 2. By doing so, the front, rear, left, and right end edge portions of the lower surface 2a of the circuit board 2 come into contact with the guide surfaces 22a (see FIG. 4) of the plurality of claw bodies 17. Also, the opening edge of the through hole 2c of the lower surface 2a of the circuit board 2 comes into contact with the guide surface 22a (see FIG. 7) of the claw body 19. From this state, when the circuit board 2 is further depressed downward, a depressing force deforms the body portions 21 of the claw bodies 17 in a curvature manner outward the body portions 21 of the claw bodies 17 outward, and the hook portions 22 are displaced outward together with the body portions 21. Similarly, due to the depressing force, the body portion 21 of the claw body 19 deforms in a curvature manner frontward, and the hook portion 22 is displaced forward together with the body portion 21. With this, the front, rear, left, and right end edge portions of the circuit board 2 move over the hook portions 22 of the claw bodies 17, and the hook portion 22 of the claw body 19 passes through the through hole 2c of the circuit board 2, and thus the lower surface 2a of the circuit board 2 comes into contact with the upper surface of the first contact portions 14.

When the lower surface 2a of the circuit board 2 comes into contact with the first contact portions 14, the curvature deformation of the body portions 21 of the claw bodies 17 and 19 is canceled, and the hook portions 22 of the claw bodies 17 and 19 restore to the original state. Then, as shown in FIG. 4, the taper surfaces 22b of the hook portions 22 of the claw bodies 17 hook onto the end edge portion of the upper surface 2b of the circuit board 2. Also, as shown in FIG. 7, the taper surface 22b of the hook portion 22 of the claw body 19 hooks onto the opening edge portion of the through hole 2c in the upper surface 2b of the circuit board 2.

Accordingly, the circuit board 2 is held while being sandwiched between the hook portions 22 of the claw bodies 17 and 19 and the first contact portions 14 in the up-down direction, and attached to the first case 3. Also, in this state, the flat surfaces 22c of the hook portions 22 of the claw bodies 17 and 19 are disposed opposing the upper surface 2b of the circuit board 2. For this reason, even if the circuit board 2 moves upward due to vibrations or the like, by the upper surface 2b of the circuit board 2 coming into contact with the flat surfaces 22c of the hook portions 22, the circuit board 2 can be prevented from coming off upward from the first case 3.

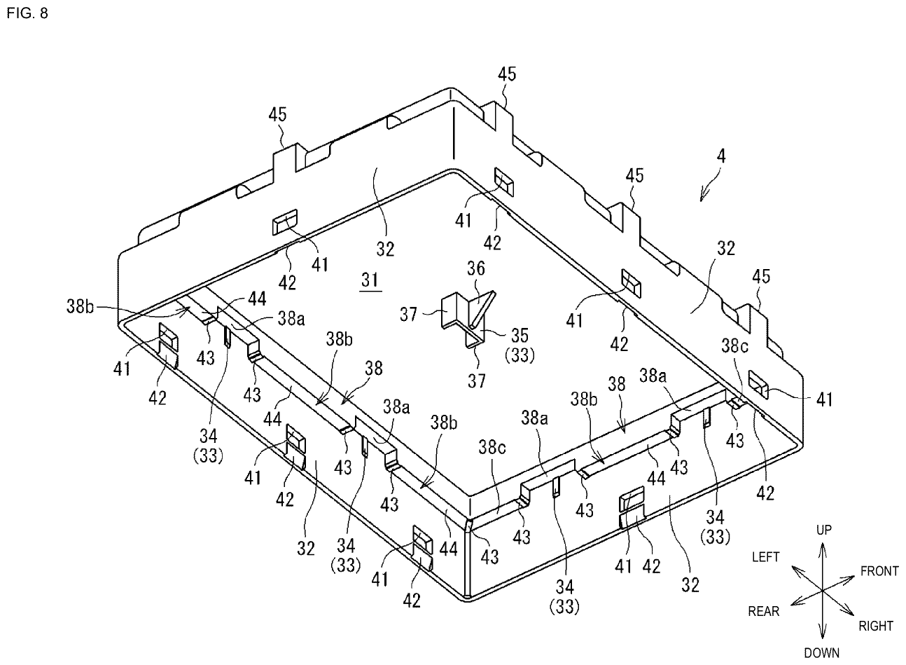

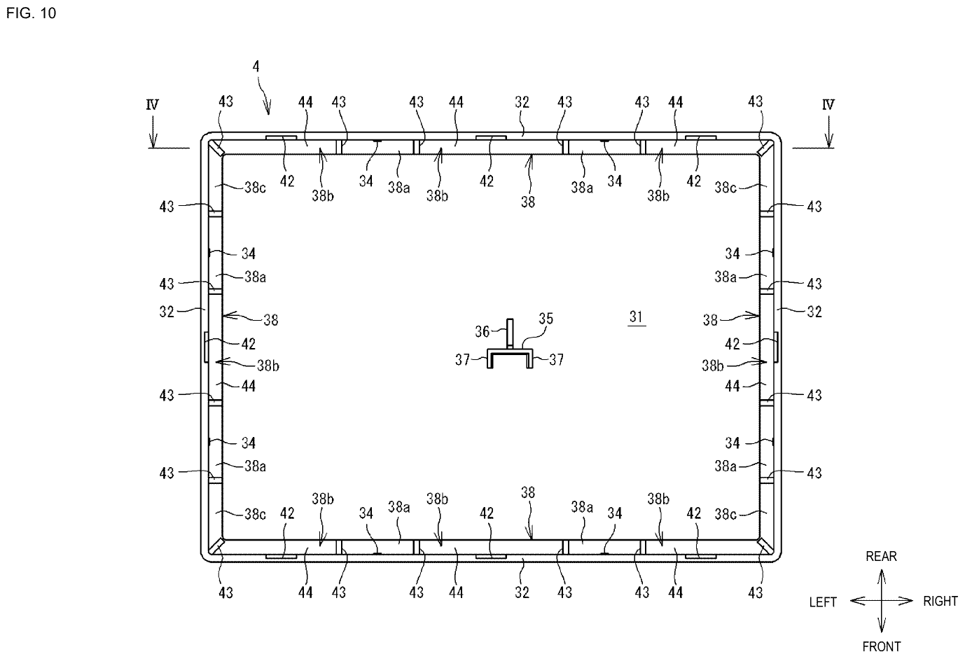

FIG. 8 is a perspective view of the second case 4 as viewed from below. In FIG. 8, the second case 4 includes a plurality of restricting portions 33 for restricting the curvature deformation of the claw bodies 17 and 19 of the first case 3 (see FIG. 3). The plurality of restricting portions 33 each include two first restricting portions 34 provided at intervals on the corresponding second side wall 32, and one second restricting portion 35 provided in the center portion of the bottom wall 31 (see also FIG. 10).

In FIGS. 4 and 8, the first restricting portions 34 come into contact with the claw bodies 17 of the first suppressing portions 15A to restrict outward curvature deformation of the claw bodies 17. The first restricting portions 34 protrude inward and extend in the up-down direction on the upper side of the inner surfaces of the second side walls 32. In a state where the claw bodies 17 hook onto the upper surface 2b of the circuit board 2, the inner surfaces (protruding end surface) of the first restricting portions 34 come into surface contact with the outer surfaces of the claw bodies 17.

In FIGS. 7 and 8, the second restricting portion 35 is configured to come into contact with the claw body 19 of the second suppressing portion 15B to restrict the forward curvature deformation of the claw body 19. The second restricting portion 35 has a flat plate shape, for example. The second restricting portion 35 protrudes downward at the center portion of the lower surface of the bottom wall 31. In a state where the claw body 19 hooks onto the upper surface 2b of the circuit board 2, a rear surface of the second restricting portion 35 comes into surface contact with the front surface of the claw body 19. A rib 36 fixed to the lower surface of the bottom wall 31 is connected to the front surface of the second restricting portion 35. A pair of ribs 37 fixed to the lower surface of the bottom wall 31 are connected to left and right end portions of the rear surface of the second restricting portion 35. In this manner, the second restricting portion 35 is reinforced by the ribs 36 and 37 in the front-rear direction.

With the above configuration, when the second case 4 is fixed to the first case 3 as described later, the inner surface of the first restricting portions 34 comes into surface contact with the outer surface of the corresponding claw body 17 (see FIG. 4), and the rear surface of the second restricting portion 35 comes into surface contact with the front surface of the claw body 19 (see FIG. 7). In this manner, the curvature deformation of the claw bodies 17 and 19 of the first case 3 is restricted.

### Fixing Structure of First Case and Second Case

In FIGS. 1 and 2, the first side walls 12 of the first case 3 include protruding portions 27 that protrude toward the second side walls 32 of the second case 4. In the present embodiment (see also FIG. 5), the front and rear first side walls 12 each include three protruding portions 27 provided at intervals in the left-right direction with the first suppressing portion 15A interposed therebetween on the outer surface thereof. The left and right first side walls 12 each include one protruding portion 27 provided between the pair of first suppressing portions 15A (center portion in the front-rear direction) on the outer surface thereof.

The second side walls 32 of the second case 4 each include fitting holes 41 that are respectively formed in positions corresponding to the opposing protruding portions 27 of the first side wall 12. In the present embodiment (see also FIG. 8), three fitting holes 41 are formed at intervals in the left-right direction of each of the front and rear second side walls 32. One fitting hole 41 is formed in the center portion in the front-rear direction of each of the left and right second side walls 32. Each protruding portion 27 of the first side walls 12 is forcibly fitted to the corresponding fitting hole 41 of the second side walls 32. This will be described in detail later.

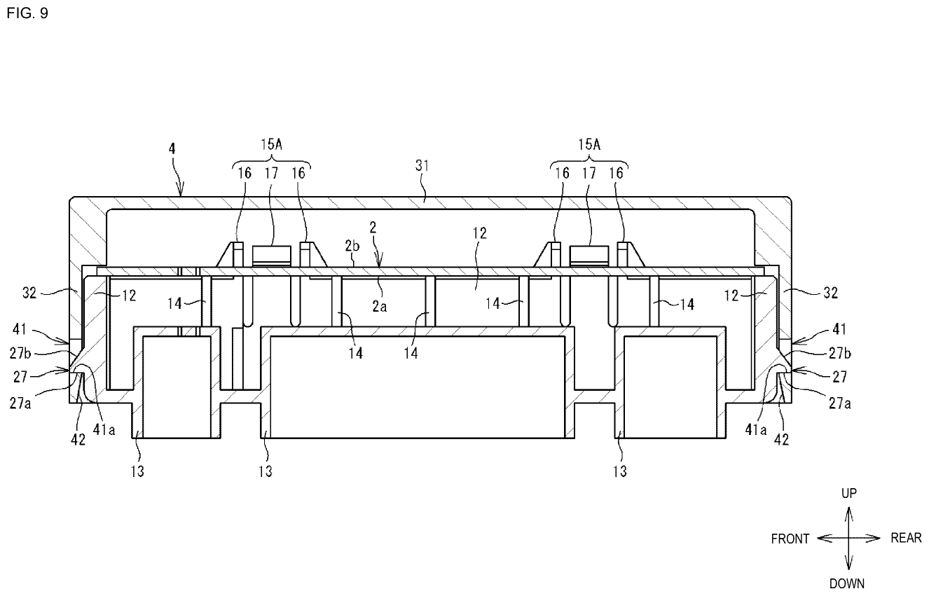

FIG. 9 is a cross-sectional view taken along arrow III-III in FIG. 5. FIG. 9 also shows a cross-section of the second case 4 in the state shown in FIG. 1. As shown in FIG. 9, a fitting surface 27a is provided at the lower end of each protruding portion 27 at the first side walls 12. Each fitting surface 27a horizontally extends outward from the outer surface of the first side wall 12. A guide surface 27b is formed on the upper side of each protruding portion 27. Each guide surface 27b obliquely extends downward and outward from the outer surface of the corresponding first side wall 12.

In FIGS. 8 and 9, the fitting holes 41 of the second side walls 32 are rectangular holes that each extend through the corresponding second side wall 32 in the thickness direction. The fitting holes 41 have a size that allows insertion of the protruding portion 27 (see also FIG. 1). The lower surface of each fitting hole 41 is a fitted surface 41a with which the fitting surface 27a of the protruding portion 27 comes into surface contact and is fitted. A guided surface 42 is formed below each fitting hole 41 in the inner surface of the corresponding second side wall 32. Each guided surface 42 obliquely extends downward and outward from the vicinity of the fitting hole 41 to the lower end of the second side wall 32, on the inner surface of the corresponding second side wall 32.

FIG. 10 is a plan view of the second case 4 as seen from below. In FIGS. 8 and 10, the second case 4 includes a stepped portion 38 provided on the inner side of each second side walls 32. Each stepped portion 38 protrudes inward over the entirely in the longitudinal direction on the upper side of the inner surface of the corresponding second side wall 32.

The lower surfaces of the stepped portions 38 of the front and rear second side walls 32 each have two recessed surfaces 38a and three protruding surfaces 38b. The protruding surfaces 38b are formed in the center portion and two end portions in the longitudinal direction of the stepped portion 38, respectively. Each recessed surface 38a is formed between the adjacent protruding surfaces 38b.

Each lower surface of the stepped portions 38 of the left and right second side walls 32 has two recessed surfaces 38a, one protruding surface 38b, and two protruding surfaces 38c. The protruding surface 38b is formed in the center portion in the longitudinal direction of the stepped portion 38. The protruding surfaces 38c are respectively formed at two end portions in the longitudinal direction of the corresponding stepped portion 38. The recessed surfaces 38a are respectively formed between the adjacent protruding surfaces 38b and 38c.

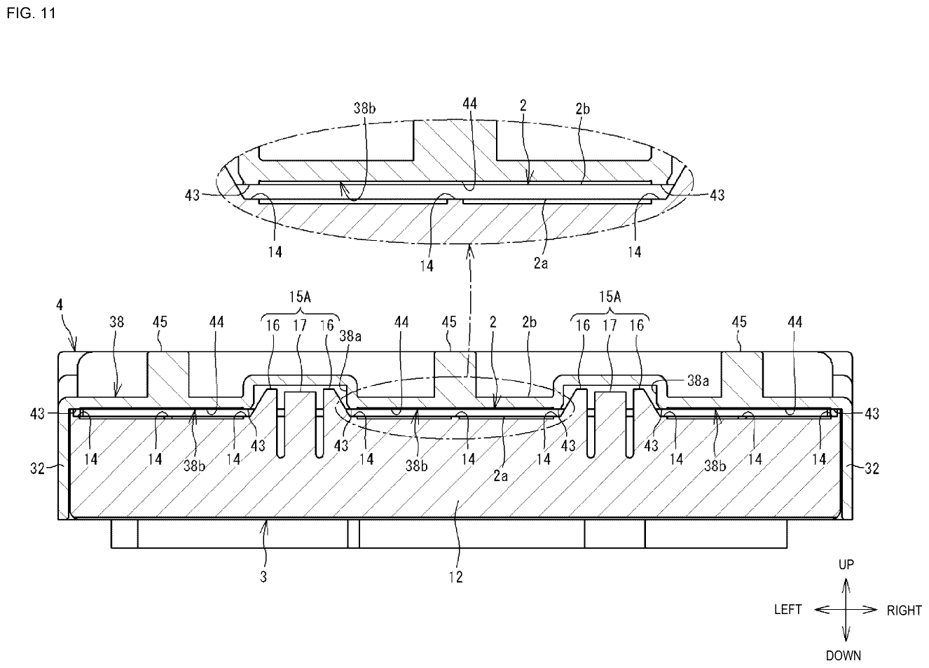

FIG. 11 is a cross-sectional view taken along arrow IV-IV in FIG. 10. FIG. 11 also shows a cross section of the circuit board 2 and the first case 3 in the state shown in FIG. 1. In FIGS. 8 and 11, the recessed surfaces 38a of the stepped portions 38 are respectively formed at positions corresponding to the first suppressing portions 15A of the first case 3. Accordingly, the stepped portions 38 do not interfere with the first suppressing portions 15A when the second case 4 is fixed to the first case 3.

Each protruding surface 38b is formed such that the center portion thereof in the longitudinal direction is located above the fitting hole 41 of the second side wall 32. A pair of second contact portions 43 protruding downward are respectively provided at the two ends in the longitudinal direction of each protruding surface 38b. Accordingly, each protruding surface 38b is provided with the pair of second contact portions 43 at positions apart from the fitting hole 41 on both sides in the longitudinal direction.

The pair of second contact portions 43 protruding downward are respectively provided at two end portions in the longitudinal direction of each protruding surface 38c. One second contact portion 43, which is provided in common to the two protruding surfaces 38b and 38c, is formed at a corner portion to which the protruding surfaces 38b and 38c of the adjacent second side walls 32 are connected to each other. Note that the second contact portion 43 of the protruding surfaces 38b and 38c may be separately formed at the corner portion.

The lower surfaces of the second contact portions 43 of each second side wall 32 come into surface contact with the corresponding end portion of the upper surface 2b of the circuit board 2. For example, the lower surfaces of the second contact portions 43 of the front second side wall 32 come into surface contact with the front end portion of the upper surface 2b of the circuit board 2. The second contact portions 43 of the present embodiment are disposed above the first contact portions 14 of the first case 3 with the circuit board 2 interposed between the first contact portions 14 and the second contact portions 43. In this manner, the second side walls 32 are supported by the first side walls 12 via the second contact portions 43 and the circuit board 2.

Portions between the pairs of second contact portions 43 of the protruding surfaces 38b are non-contact portions 44 that do not come into contact with the upper surface 2b of the circuit board 2. For this reason, the portions below the non-contact portions 44 of the second side walls 32, that is, the peripheral portions of the fitting holes 41 are likely to deform in a flexural manner downward using the pair of the second contact portions 43 at the two respective sides in the longitudinal direction as the starting point. Accordingly, the flexural deformation of the peripheral portion of the fitting holes 41 of the second side walls 32 is allowed by the non-contact portions 44.

Pressing portions 45 for deforming the second side walls 32 in a flexural manner by pressing the second side walls 32 downward are formed above the non-contact portions 44 of the corresponding second side wall 32 (see also FIG. 1). The pressing portions 45 of the present embodiment are formed on the upper portion of the outer surfaces of the second side walls 32. By depressing the pressing portions 45 downward, the peripheral portion of each fitting hole 41 of the second side walls 32 can also be easily deformed in a flexural manner.

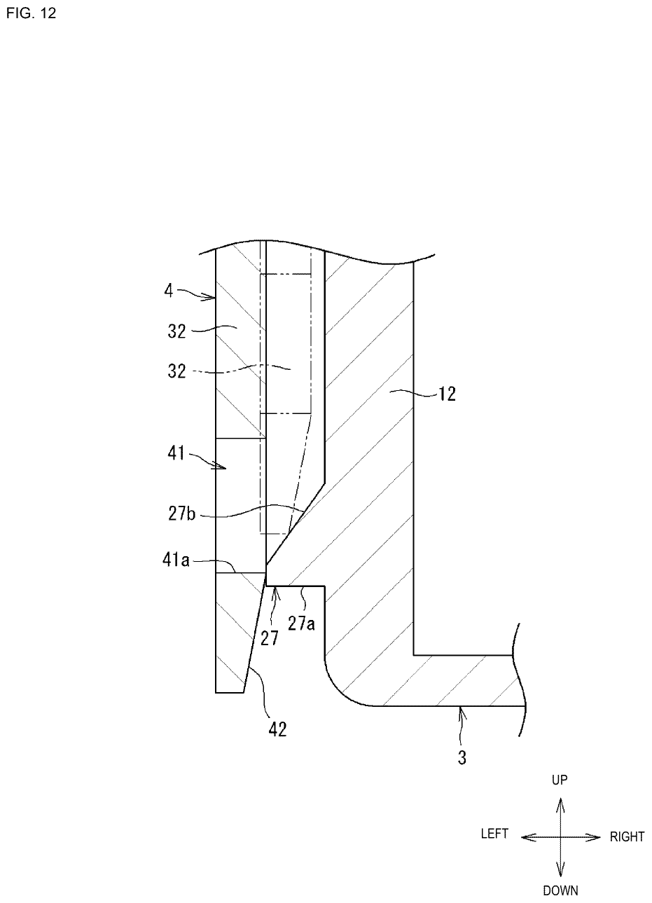

With the above configuration, when fixing the second case 4 to the first case 3, from the state shown in FIG. 2, the circuit board 2 is attached to the first case 3 as described above, and then the second case 4 is moved downward. By doing so, the second side walls 32 of the second case 4 move downward while covering the first side walls 12 of the first case 3 from the outer side, and then, as shown by the two-dot chain lines in FIG. 12, the lower ends of the second side walls 32 come into contact with the guide surfaces 27b of the protruding portions 27 of the first side walls 12.

Further, when the second case 4 is moved downward, the guided surfaces 42 move downward while coming into contact with the guide surfaces 27b, respectively, and thus the second side walls 32 are gradually pressed outward. Then, by the second contact portions 43 coming into contact with the upper surface 2b of the circuit board 2, the second case 4 is restricted from moving downward. At this time, as indicated by the solid lines in FIG. 12, the guided surfaces 42 move downward relative to the guide surfaces 27b, and the fitting holes 41 of the second side walls 32 are located slightly above the protruding portions 27 of the first side walls 12.

In the state shown in FIG. 12, the pressing portions 45 of the second side walls 32 are depressed downward. By doing so, the peripheral portions of the fitting holes 41 of the second side walls 32 deform in a flexural manner, and thus the fitting holes 41 of the second side walls 32 are depressed to the positions corresponding to the protruding portions 27 of the first side walls 12. In this manner, as shown in FIG. 9, the protruding portions 27 of the first side walls 12 are forcibly fitted to the fitting holes 41 of the second side walls 32.

### Effects of the Present Embodiment

According to the electrical junction box 1 of the present embodiment, in the second case 4, in the state where the pairs of second contact portions 43 coming into contact with the end portions of the upper surface 2b of the circuit board 2, the non-contact portions 44 that do not come into contact with the end portions allow the flexural deformation of the second side walls 32. Accordingly, by deforming the second side walls 32 in a flexural manner, the protruding portions 27 of the first side walls 12 of the first case 3 can be forcibly fitted to the corresponding fitting holes 41 formed in the second side walls 32 of the second case 4. By doing this, the circuit board 2 is held while being sandwiched between the first contact portions 14 of the first case 3 and the second contact portions 43 of the second case 4 in the up-down direction. Accordingly, looseness of the circuit board 2 in the up-down direction can be effectively suppressed without using screws. Also, since the first contact portions 14 come into surface contact with the lower surface 2a and the second contact portions 43 come into surface contact with the upper surface 2b of the circuit board 2, the looseness of the circuit board 2 in the up-down direction can be more effectively suppressed.

By using the curvature deformation of the claw bodies 17 and 19 of the first case 3 with respect to the first side walls 12, the circuit board 2 is held while being sandwiched between the first contact portions 14 and the claw bodies 17 and 19 of the first case 3 in the up-down direction as well. In this manner, looseness of the circuit board 2 in the up-down direction can be more effectively suppressed. Further, since the taper surfaces 22b of the claw bodies 17 and 19 come into line contact with the edge portion of the upper surface 2b of the circuit board 2, even if a dimensional error occurs in any of the circuit board 2 or the claw bodies 17 and 19, the claw bodies 17 and 19 can reliably hook onto the upper surface 2b of the circuit board 2.

Due to the first restricting portions 34 and the second restricting portion 35 of the second case 4, the claw bodies 17 and 19 of the first case 3 are held while hooking onto the upper surface 2b of the circuit board 2, and thus looseness of the circuit board 2 can be more effectively suppressed.

### Other Matters

In the electrical junction box 1 of the present embodiment, the first case 3 is disposed on the lower side and the second case 4 is disposed on the upper side, but the first case 3 may be disposed on the upper side and the second case 4 may be disposed on the lower side. The electrical junction box 1 of the present embodiment has the configuration in which looseness of the circuit board 2 is suppressed by forcibly fitting the protruding portions 27 into the fitting holes 41 and the configuration in which looseness of the circuit board 2 is suppressed by using the curvature deformation of the claw bodies 17 and 19, but the looseness of the circuit board 2 may be suppressed by only one of the two configurations.

The embodiment disclosed here is to be considered in all respects as illustrative and not limiting. The scope of the present disclosure is indicated by the scope of the claims rather than the meaning described above, and is intended to include all changes within the meaning and scope equivalent to the scope of the claims.

1. An electrical junction box comprising:
a circuit board;
a first case including a first side wall and covering one surface of the circuit board;
a second case including a second side wall that covers the first side wall from an outer side, the second case covering another surface of the circuit board opposite the one surface;
wherein the first side wall includes a protruding portion protruding toward the second side wall,
the second side wall includes a fitting hole into which the protruding portion is forcibly fitted by flexural deformation of the second side wall,
the first case includes a first contact portion configured to come into contact with the one surface of the circuit board, and
the second case includes:
a pair of second contact portions that come into contact with the other surface of the circuit board at two positions interposing the fitting hole of the second side wall therebetween, and
a non-contact portion that does not to come into contact with the other surface between the pair of second contact portions in order to allow the flexural deformation of the second side wall.

2. The electrical junction box according to claim 1,
wherein the first case further includes a claw body that is deformable in a curvature manner toward the second side wall side with respect to the first side wall, and
the claw body allows the first contact portion to come into contact with the one surface of the circuit board by the curvature deformation, and is formed such that the claw body hooks onto the other surface of the circuit board by the curvature deformation being canceled in the state where the first contact portion is in contact with the one surface of the circuit board.

3. The electrical junction box according to claim 2,
wherein the second case further includes a restricting portion that restricts the curvature deformation by coming into contact with the claw body in a state where the claw body hooks onto the other surface of the circuit board.

4. An electrical junction box comprising:
a circuit board;
a first case including a first side wall and covering one surface of the circuit board;
a second case including a second side wall that covers the first side wall from an outer side, the second case covering another surface of the circuit board opposite the one surface;
wherein the first case includes:
a first contact portion that comes into contact with the one surface of the circuit board, and
a claw body that is deformable in a curvature manner toward the second side wall side with respect to the first side wall, and
the claw body allows the first contact portion to come into contact with the one surface of the circuit board by the curvature deformation, and is formed such that the claw body hooks onto the other surface of the circuit board by the curvature deformation being canceled in the state where the first contact portion is in contact with the one surface of the circuit board.
